(19) United States
(12) Patent Application Publication
(10) Pub. No.: US 2007/0244869 A1
(43) Pub. Date: Oct. 18, 2007

(54) METHOD AND SYSTEM OF SEARCHING

(76) Inventor: DAVID GROSS, Portland, OR (US)

Correspondence Address: DAVID GROSS, 7832 SW 27th Ave., PORTLAND, OR, 97219, US

(21) Appl. No.: 11/559,976

(22) Filed: Nov. 15, 2006

Related U.S. Application Data
(60) Provisional application No. 60/773,352, filed on Feb. 15, 2006.

(51) Int. Cl. G06F 7/06

(52) U.S. Cl. 707/3

(57) ABSTRACT

The invention is concerned with a method and system for searching databases. It allows the user to get proper search results by classifying the user identity. A child, an adult, a Professor or even a labor worker, will get the searching results per their knowledge and expertise. A chosen weighted words applying the search engine and user databases are classifies to give these proper results. Each searched document is now mapping according these values and sent to the searcher according its score.

### CROSS-REFERENCE TO RELATED APPLICATION

This application claims the benefit of U.S Provisional Patent Application No. 60/735,827 filled on 14 Nov. 2005 entitled Method and System Of Searching and claims the benefit of U.S Provisional Patent Application No. 60/773,352 filled on 15 Feb. 2006 entitled Method and System of Searching, which are hereby incorporated by references.

### FIELD OF THE INVENTION

The present invention relates to searching, in particular searching of electronic data whether in a database or on a network, including the Internet and Intranet.

### BACKGROUND OF THE INVENTION

There is an enormous amount of information on the Internet—Google™ today performs searches among 8 billion pages. However, while it may take just seconds to enter the chosen keyword(s) into the search engines and get the results, actually finding the desired information amongst all the results can take much longer. Even users using advanced search options still need to go through many pages of search results not relevant or appropriate to their needs. The problem is that there is currently no system that gives a good correlation between the person executing the search and the search results themselves.

Actually, searching for information on the Internet is essentially a two-way process between the surfer and the database, such the Web. That is to say, between two databases. In other words, the problem is to say, how can the search engine provide exact information, when it is only actually confronted by a limited number of search words, and it is not exposed to the whole database (the brain) of the surfer.

On the other hand, search engines today, gives the option to get a personal results based on the history of user searching. This brings a privacy problem, of using this data by the search engine company or by anyone else.

### SUMMARY OF THE INVENTION

The solution provided by means of the new invention is to map the two databases in a new way, and finds compatibility between the two. In order to acquire a characterization of the surfer, various features will be defined, such as: “child”, “adult”, “scientist”, “sportsman”, etc.

On the other hand, preferences will be given to the words in the dictionary compatible to these features. As an example, the word “notebook” will get a high value for “child”, but its value will be lower for “sportsman”. This is a pre-defined system, which allows the user to get proper results without giving his searching history or any personal data.

According to one embodiment of the invention, a professional user can have specific database words affecting the searching results. For example, a physics student will add to the common words appear in the database, specific words such as: “Black hole”, “Nebula”, “Einstein” and the like.

According to another embodiment of the present invention, the user database is pre-defined by the search engine company using the invention.

According to another embodiment of the present invention, the user can have a pre-defined profile such as: child, adult, musician and the like, with only one clicking on the proper icon on the user screen. This embodiment allows the user to get proper results without any need of putting specific words or using his searching history.

### BRIEF DESCRIPTION OF THE DRAWINGS

In the Drawings:

FIG. 1 is a schematic illustration depicting one embodiment of the turbo searching system of the present invention.

FIG. 2 is a schematic illustration depicting another embodiment of the turbo search engine of the present invention.

FIG. 3 schematically illustrates an exemplary client system.

FIG. 4 schematically illustrates an exemplary client system and insider components.

FIG. 5 is a schematic illustration depicting the computer display screen of client.

FIG. 6 is a schematic illustration depicting an exemplary set of defined weighted-database.

FIG. 7 is a schematic illustration depicting an exemplary classified set of defined weighted-database.

FIGS. 8a-8f depict an exemplary result obtained using the turbo method of the present invention

FIG. 9 is a schematic illustration depicting the method of using the turbo unit of the turbo search engine of the present invention.

FIG. 10 illustrates the flow of a search carried out using a turbo server.

FIG. 11 illustrates an optional client usage of a private turbo unit.

FIG. 12 shows the Home page of a website for searching the Internet.

FIG. 13 shows the results Internet page for the turbo search method.

FIG. 14 shows the database administration of the turbo search method.

FIG. 15 shows an example of database results, which include words with initials letter ‘m’.

FIG. 16 shows example database results, which include words with initials letter ‘h’.

FIG. 17 shows example database results, which include words with initials letter ‘n’.

FIG. 18 is an example of searching a specific word in the private turbo client.

### DETAILED DESCRIPTION OF PREFERRED EMBODIMENTS

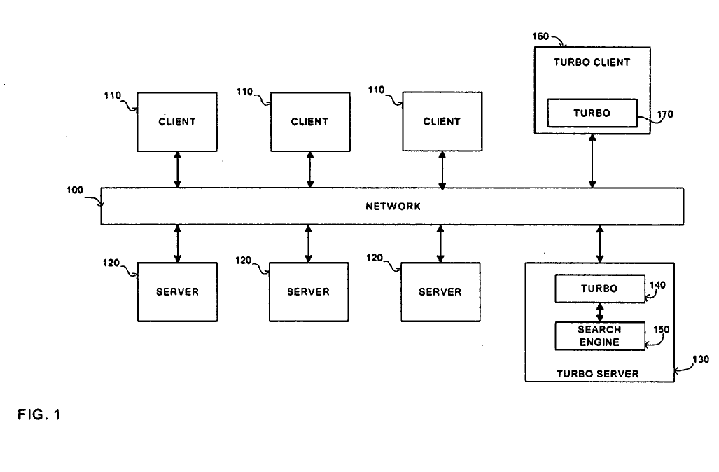

FIG. 1 is a schematic illustration depicting one embodiment of the turbo searching system of the present invention. Network 100 is connecting between clients 110 and servers 120; turbo server 130 comprises turbo unit 140 and search engine 150. Each of clients 110 comprises a computer unit. Each of the servers 120 comprises a network server. Turbo server 130 receives client-specific parameters (which are selected by each client) and search keywords as an input data. Turbo server 130 analyses the input data by providing a weighted set of result documents (e.g., web site addresses, published documents) based on the client-specific parameters, the search key words and a defined weighted-database(s). Turbo unit 140 comprises the weights of words based on a defined weighted-database and search engine 150 comprises statistical and computational units used for data analysis.

A turbo client 160 uses search results from a regular server or from a turbo server.

Turbo database 170 comprises the weights of words based on a defined weighted-database. Turbo client 160 can chose using a private turbo search by activating the turbo database 170 or getting results of a regular search.

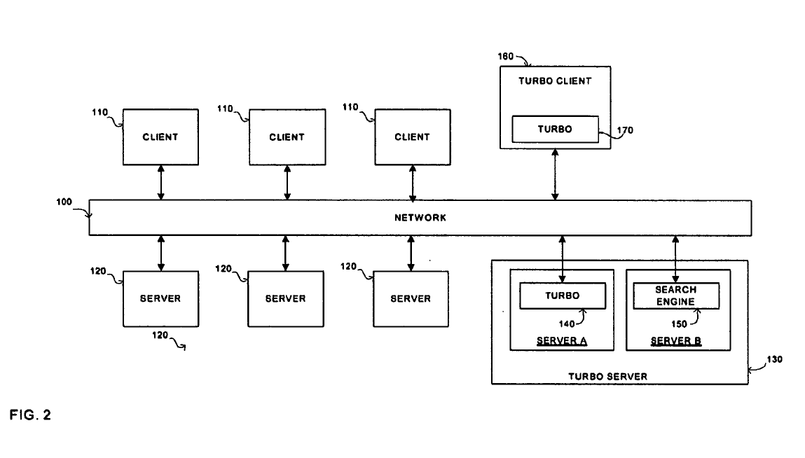

FIG. 2 is a schematic illustration depicting another embodiment of the turbo search engine of the present invention. Network 100 is connecting between clients 110 and turbo client 160 and servers 120; Turbo server 130 comprises two separated servers: Server A, which comprises the turbo unit 140 and server B including the search engine 150. The turbo server functions as described in FIG. 1.

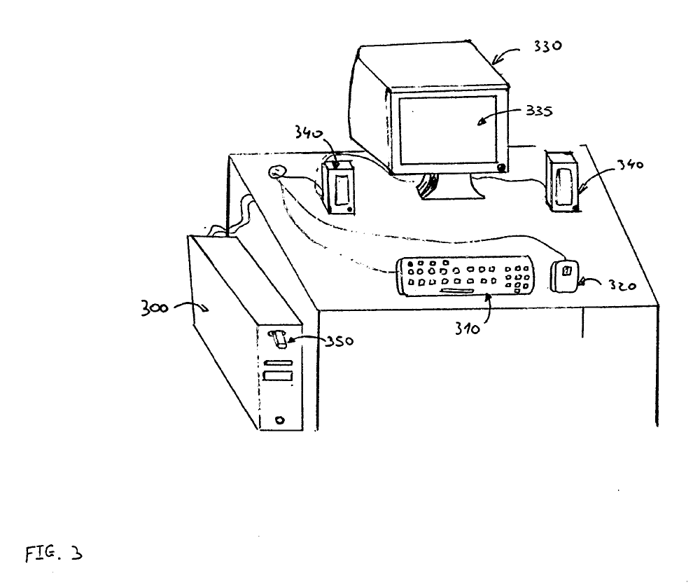

FIG. 3 schematically illustrates an exemplary client 110; Client 110 comprises a computer 300, an external storage device 350, a keyboard 310, a mouse 320, speakers 340, a monitor 330 and a display screen 335.

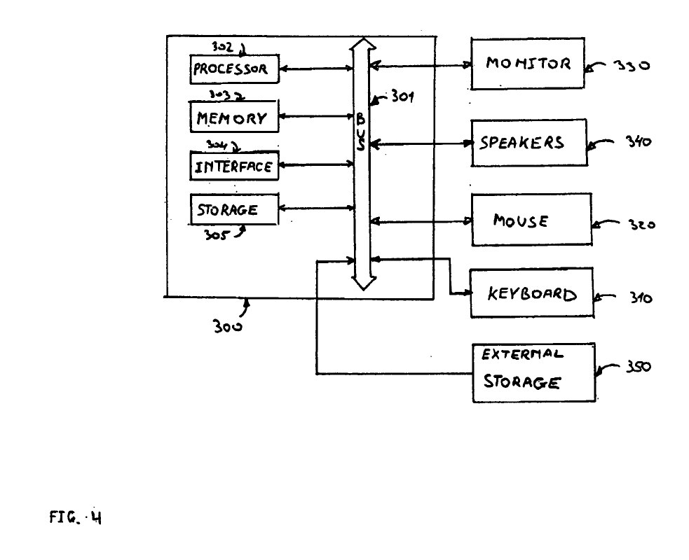

FIG. 4 schematically illustrates an exemplary client 110; Client 110 comprises a computer 300, an external storage device 350, a keyboard 310, a mouse 320, speakers 340 and a monitor 330. Computer 300 comprises BUS 301, processor 302, memory 303, interface 304, and storage 305. Interface 304 can be a network interface and the like.

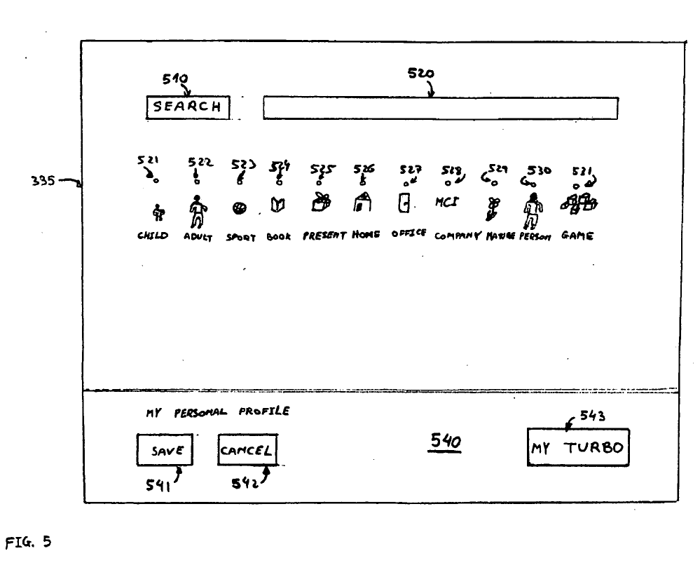

FIG. 5 is a schematic illustration depicting the computer display screen 335 of client 110. Display screen 335 includes a search key 510, a ruler 520 for typing search keywords and multiple check buttons (such as check buttons 521-531) for selecting client-specific parameters. Display screen 335 further includes a personal profile unit 540 which includes a save push button 541 and a cancel push button 542 for saving or canceling the personal profile parameters, respectively. Push button 543 activating the private turbo unit of the client. By using the turbo unit, the client can affect the search results order by sorting them per the new method describes in this application.

FIG. 6 is a schematic illustration depicting an exemplary set of defined weighted-database 600 in which the first row 620 includes a list of parameters (e.g., child, man, sport, present, company, game, nature, book, etc.) and the first column 610 includes a list of words from a dictionary, each of which has a distinct weight or value 630 when selected by one of the parameters listed in the first row. For example, the word “toy” has a value of “10” under the selection of a “child” parameter, while the same “toy” word has a value of “1” under the selection of a “company” parameter. Another example, the word “car” has a value of “9” under the selection of a “man” parameter, while the same “car” parameter has a value of “10” under the selection of a “child” parameter.

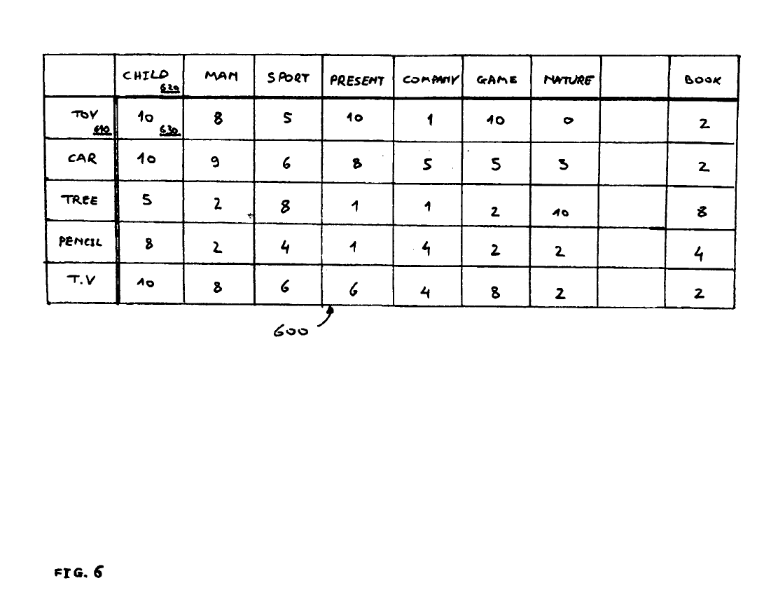

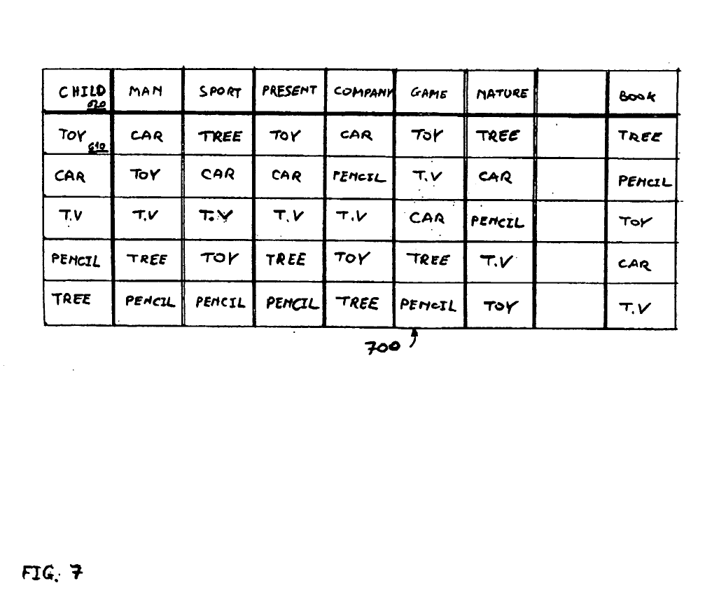

FIG. 7 is a schematic illustration depicting an exemplary classified set of defined weighted-database 700, which is a sorted version of the defined weighted-database 600 shown in FIG. 6. For example, under the selection of a “child” parameter, the heaviest word (i.e., which gets the highest value) is the word “toy” 610, which appears at the top of “child” column 620. The word “tree” under the selection of a: “child” appears at the bottom of the column with the weakest value.

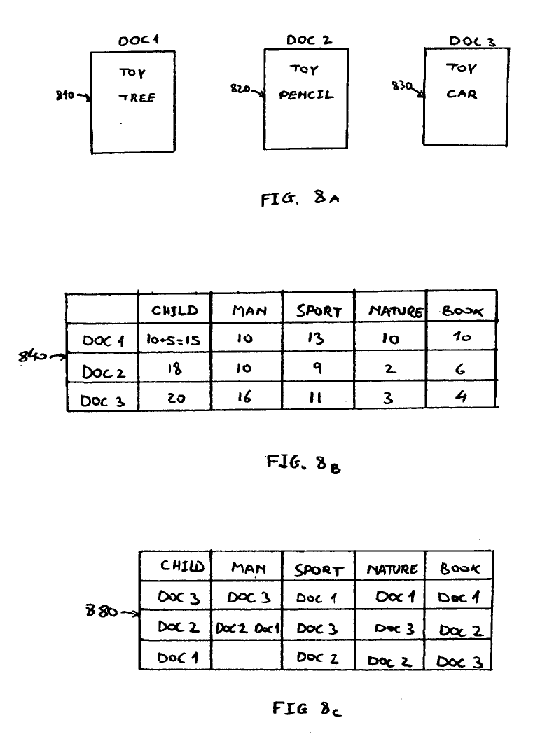

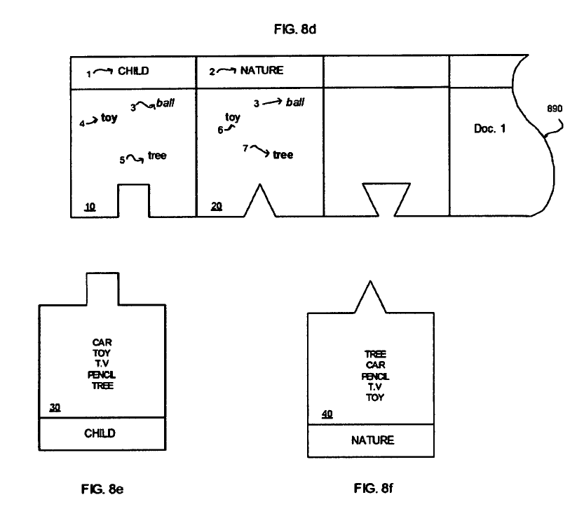

FIGS. 8a-8c depict an exemplary result obtained using the turbo method of the present invention, which uses turbo server 130 as shown in FIG. 1. FIG. 8a illustrates three exemplary documents: document 1 (DOC 1, 810) which includes the words “toy” and “tree”document 2 (DOC 2, 820) which includes the words “toy” and “pencil” and document 3 (DOC 3, 830) which includes the words “toy” and “car”. FIG. 8b presents Table 840, which includes the calculated values of each of the documents depending on the parameters selected by the client for each search. These values can be calculated using various statistics and/or simple mathematics. For example, the value of document 1 (DOC 1) when the “child” parameter was selected is 15 which comprises the additive value of “toy” which is “10” and the value of “tree” which is “-5”. FIG. 8c presents Table 880, which includes the sorted weighted documents under each selected parameter. For example, when the “child” parameter is selected, the first document which will be sent back to the client from the turbo server after typing the key word toy” is document 3 (DOC 3), which includes the words “toy” and “car”. On the other hand, when the parameter selected is “nature” the first document appear when the which will be sent back to the client from the turbo server after typing the key word toy” is document 1 (DOC 1) which includes the words “toy” and “tree”.

FIGS. 8d, 8e and FIG. 8f presents mapping of turbo server 130 exemplary data document 1 (DOC 1) and users turbo server 160 exemplary users CHILD FIG. 8e and NATURE FIG. 8f.

According to one embodiment of the present invention, both databases: the user database and the search engine database are sorted for getting proper results for the user search. For the searching word “ball” 3 in Doc. 1, the category CHILD 1, get score of 15 points per the words “toy” 4 score 10, and “tree” 5 score 5 as shown in FIG. 600. Category NATURE 2, get a total score of 10 points per the words “toy”, and “tree” as shown in FIG. 600. FIG. 8e is an illustration of a CHILD user category. The sorted words 10 are with high score from up to bottom. FIG. 8f is an illustration of a NATURE user category. The sorted words 10 are with high score from up to bottom.

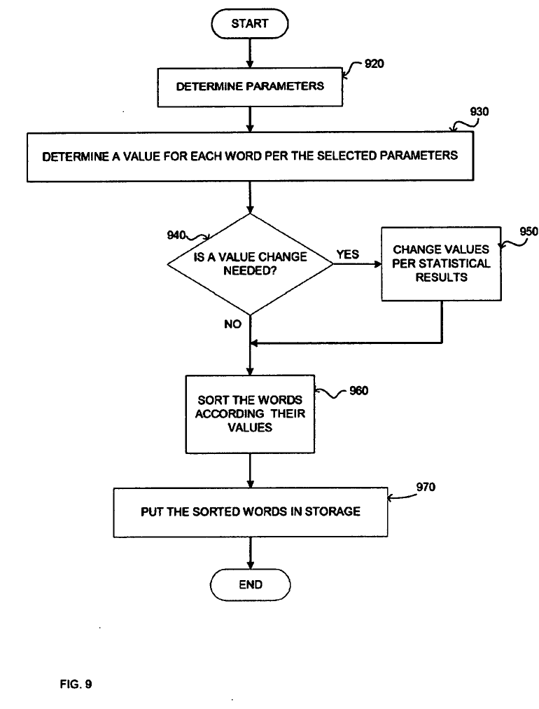

FIG. 9 is a schematic illustration depicting the method of using the turbo unit of the turbo search engine of the present invention. In step 920, the turbo determines the personalization parameters from the user. This is generally directly from the user entry or it could be from a previously saved personal profile. In step 930 the turbo assigns each parameter a weight dependent on the personalization parameters, such as shown in FIG. 6.

In steps 940 and 950, the option is provided to allow statistics to change the numbers in FIG. 6. Thus if it is noticed that many children preferred X to Y, it is possible to modify the table to reflect this choice.

In stage 960, turbo unit sorts the words according to their values, as in FIG. 7, to allow search requests to be ordered according to the values. The sorted words are now placed in memory ready to apply to actual searches.

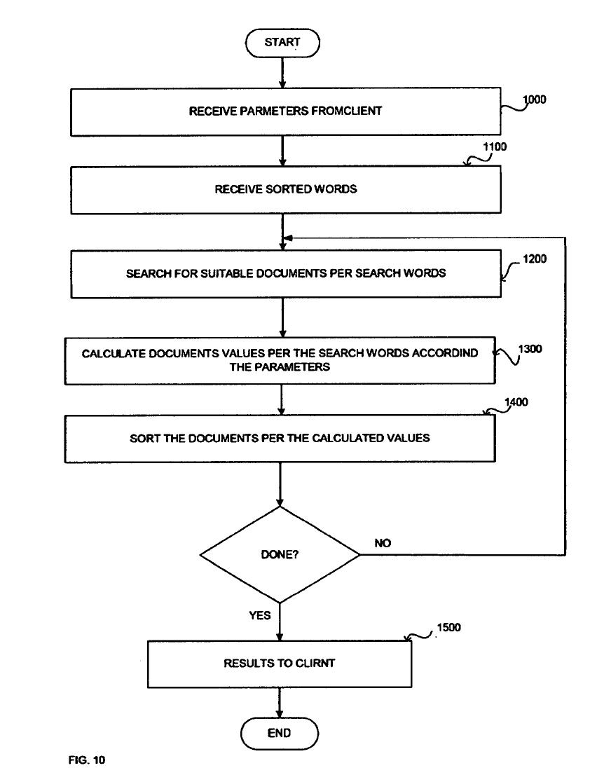

FIG. 10 illustrates the flow of a search carried out using a turbo server according to a preferred embodiment of the present invention.

In stage 1000 the search parameters are received from the user client. In stage 1100 sorted words are received from the storage in which they placed in stage 970. The search is now carried out using the words in order.

In stage 1300, calculations are being done. The searched words documents are getting values according the parameters.

In stage 1400, the documents are sorted per their calculated values.

If the process is finished, activating stage 1500, which the results are sending to client.

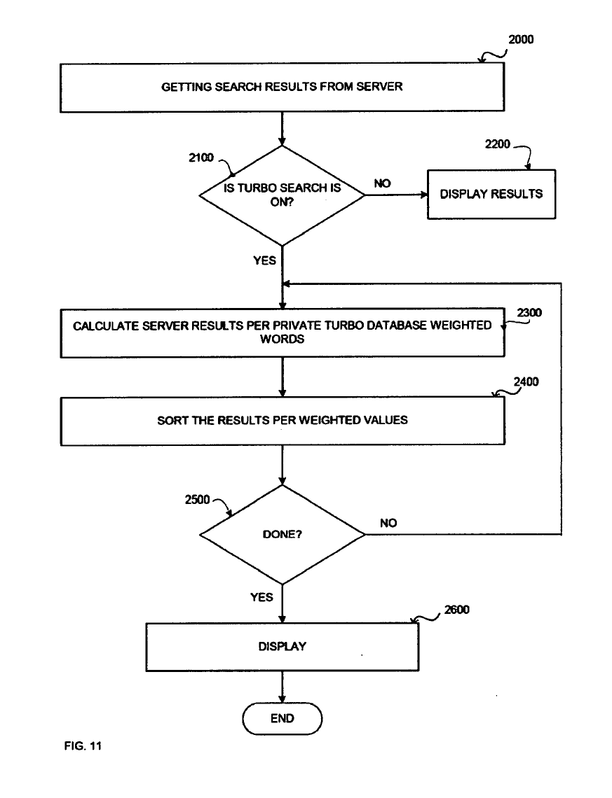

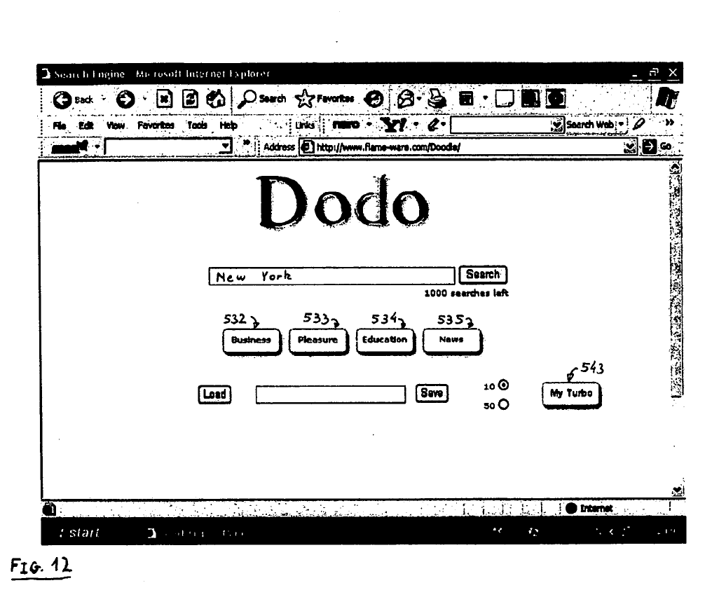

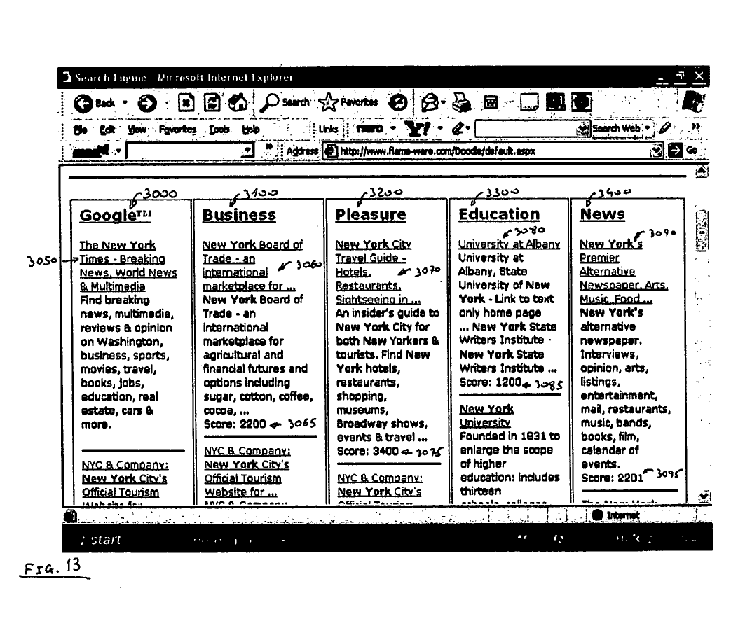

FIG. 11 illustrates an optional client usage of a private turbo unit 170.

In stage 2000, turbo client gets the search results from server or turbo server. If client didn't activate the turbo search, the results are displayed 2200, while if turbo search is activate, the flow continue to stage 2300.

In stage 2300, calculations of server results are being done. These calculations are per the private turbo database of the client, which include personal weighted words.

In stage 2400, turbo unit is sorting the results per the weighted values.

If the process is finished, the results are displaying at the client monitor.

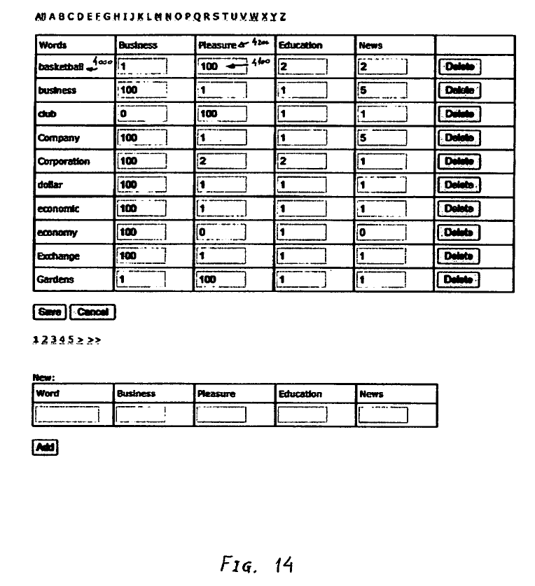

FIG. 12 shows the Home page of a website for searching the Internet as shown in FIG. 5.

The website offer four client specific parameters: Business 532, Pleasure 533, Education 534 and News 535. My Turbo 453, is a push button, which activate the personal turbo unit 170 of the client. By pressing one or more of the push buttons 532-535, the client should get closer results for his searching. Optionally, the client can activate his personal turbo unit 170 by pressing My Turbo button 543. This action causes to get results closer to the client taste and habits, cause his personal turbo unit is having his own chosen weighted words and expressions.

FIG. 13 shows the results Internet page for the turbo search method.

This figure compares Google™ results 3000 as appears at the left side, and the new method, which describes in this file at the right side.

Each column brings the results 3060, 3070, 3080 and 3090 per the suitable chosen push button parameter 532-535. FIG. 13 is a search results for a searching word: New York.

The first site achieved by a regular searching appears at no. 3050, which is:

The New York Times—Breaking News, World News & Multimedia. While the results which getting from the turbo searching is depend of the chosen parameter. For Business 3100 for example, the first result is: “New York Board of Trade—an international marketplace For . . . ”. This result got the highest score in Business category and gets 2200 points. The score achieved by the calculation of the weighted words appears in this page, optional way is including its heading and abstract.

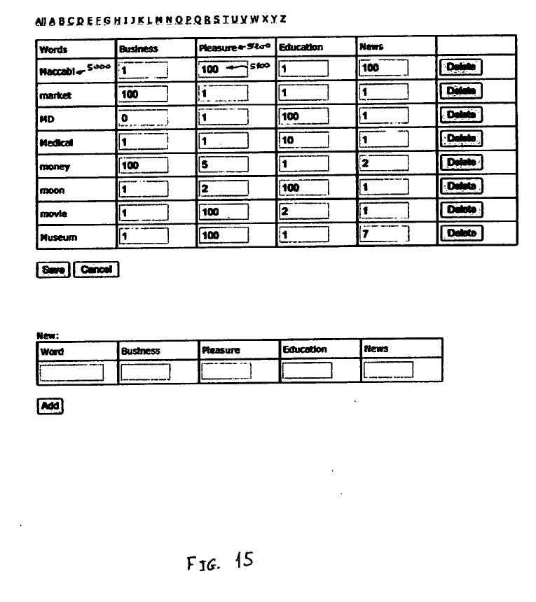

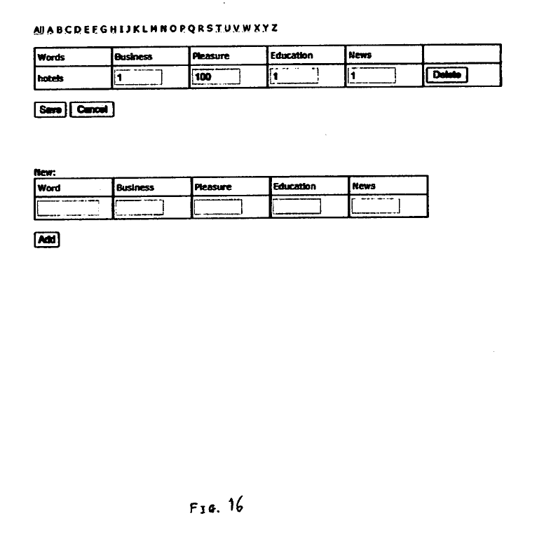

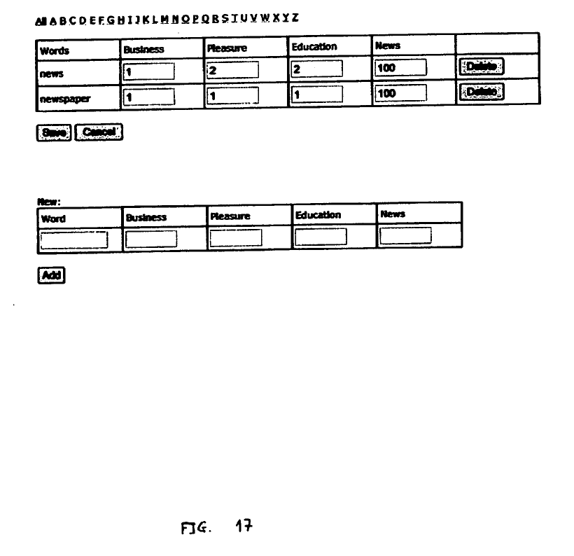

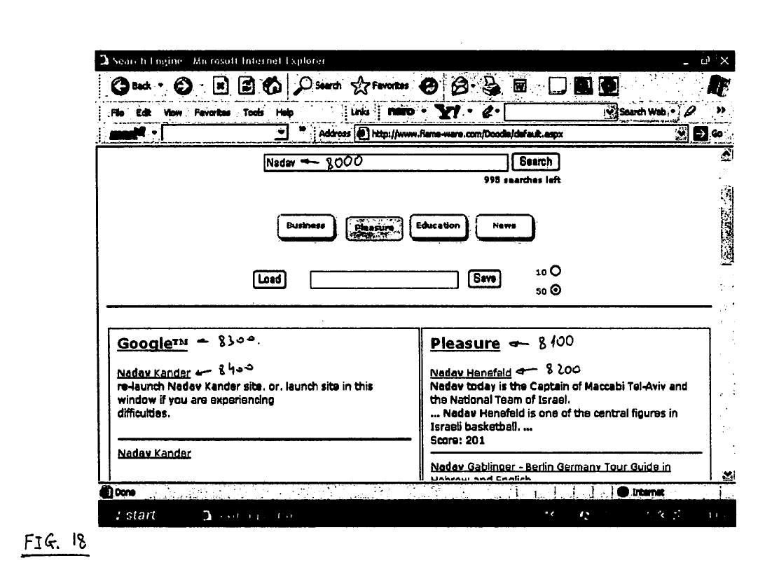

FIG. 14 shows the database administration of the turbo search method. In this web page the data is inserting for the weighted words. For example, a client who likes Maccabi Tel-Aviv basketball team, can score the word ‘basketball’ 4000 in category Pleasure 4200 with a high score of 100 points 4100, and the word ‘Maccabi’ 5000 at FIG. 15 in the category of Pleasure 5200, with a score 5100 of 100 points too.

FIG. 18 is an example of searching the search word ‘Nadav’ 8000 in the private turbo client 160. The first search result, which appears at category Pleasure 8200, is ‘Nadav Henefeld’. The reason that this is the result is that Nadav Henefeld is a basketball player at Maccabi Tel-Aviv. Cause the user like this basketball team and he already put in his private turbo 170 the words ‘basketball’ 4000 and ‘Maccabi’ 5000, an associative result came with the name of his favorite team player: Nadav Henefeld (while the Google™ 8300 first result is ‘Naday Kander’ 8400).

I claim:

1. A method for searching of databases comprising the following steps:
(A) defining secondary database, including the steps:
i. choosing searcher parameters;
ii. choosing common words; and
iii. choosing negative and positive values for said common words according said selected searcher parameters; and
iv. sorting and indexing said common words;
(B) getting searching words,
(C) searching primary database for suitable documents per said searching words,
(D) calculating the values of said documents by using said values of said common words, according said parameters,
(E) sorting said documents per said calculated values, and
(F) sending results to user.

2. A method according to claim 1 wherein secondary database is a user database.

3. A method according to claim 1 wherein step (B):
Getting searching words, includes getting data from user database.

4. A method according to claim 1 wherein a mathematical function is using to map the data.

5. A method according to claim 2 wherein the user is choosing his parameters.

6. A method according to claim 2 wherein the user is choosing additional parameters to the existing ones.

7. A method according to claim 5 wherein the user is choosing common words according his parameters.

8. A method according to claim 1 wherein there are plurality of databases of each kind.

9. A method according to claim 2 wherein there are plurality of databases of each kind.

10. A method according to claim 2 wherein there are plurality of users.

11. A method according to claim 1 wherein user parameters are of the form of age, sex, interest, identity, hobbies, profession.

12. A method according to claim 1 wherein the common words are coming one by one from a dictionary, encyclopedia, lexicon.

13. A method according to claim 11 wherein the words are part of the dictionary, encyclopedia, lexicon.

14. A method according to claim 1 wherein the documents are of any form of digital content such as text, photo, voice and sound.

15. A method according to claim 1 wherein the common words are of the form of binary word.

16. A method according to claim 1 including the comparison between calculated documents by a mathematical function.

17. A method according to claim 1 while the documents are pages from the Internet.

18. A system for searching in database comprising the elements:
Operating user computer for working on the Internet, storage for operate secondary database, input/output devices for sending and receiving searching words and user database information, and primary storage database for searching documents.

19. A system according to claim 18 wherein including plurality of users.

20. A system according to claim 18 wherein including plurality of servers.
